(19) United States
(12) Patent Application Publication
(10) Pub. No.: US 2020/0309550 A1
(43) Pub. Date: Oct. 1, 2020

(54) INFORMATION PROCESSING APPARATUS AND INFORMATION PROCESSING METHOD

(71) Applicant: Toyota Jidosha Kabushiki Kaisha, Toyota-shi Aichi-ken (JP)

(72) Inventor: Seii Sai, Yokohama-shi (JP)

(21) Appl. No.: 16/830,562

(22) Filed: Mar. 26, 2020

(30) Foreign Application Priority Data
Mar. 29, 2019 (JP) 2019-067166

(51) Int. Cl. G01C 21/34; G08G 1/13

(52) U.S. Cl. CPC G01C 21/3423; G08G 1/13

(57) ABSTRACT

An apparatus which estimates an action of a user who moves on a route composed of a plurality of segments by using a plurality of transportation means. The apparatus comprises a first obtaining unit that obtains operation-related data which is data of operation services of the public transportation facility, and which represents a scheduled departure and arrival time for each segment; a second obtaining unit that obtains a scheduled movement route which is a set of a plurality of segments; a creation unit that obtains location information from a user terminal in a periodic manner, and creates movement track record data including the location information; and an estimation unit that estimates, based on the movement track record data and the operation-related data, a transportation means used by the user, and an entering and a leaving time thereof, with respect to a corresponding segment.

### CROSS REFERENCE TO THE RELATED APPLICATION

This application claims the benefit of Japanese Patent Application No. 2019-067166, filed on Mar. 29, 2019, which is hereby incorporated by reference herein in its entirety.

### BACKGROUND

### Technical Field

The present disclosure relates to a system for collecting data related to the movement of a person.

### Description of the Related Art

Services for carrying out route search utilizing various kinds of transportation systems by using computers, smart phones, etc., are popular.

On the other hand, there is a demand for determining whether a user is moving along a proposed schedule route. For example, when it turns out that a plurality of users have not moved by changing transportation systems for facilities along a proposed route, it can be estimated that there is a problem in the proposed route, connection (transfer), etc. In addition, by what kinds of connection or transfer travelers are moving can become precious data to travel agents or transportation companies.

As a technology for tracking a moving user, for example, in Patent Literature 1, there is disclosed a system which predicts a user's action based on the usage information of an IC card boarding ticket.

### CITATION LIST

Patent Literature 1: International Publication 2014/030529

Patent Literature 2: Japanese Patent Application Laid-open No. 2011-061615

Patent Literature 3: Japanese Patent Application Laid-open No. 2011-107091

### SUMMARY

In the invention described in Patent Literature 1, the action of a user is tracked by utilizing the information at the time when the user passes through an automatic ticket gate or the like by using an IC card, and hence, the user can not be tracked in cases where he or she has moved by using public transportation systems incompatible with IC cards or by using other transportation than public transportation systems. In addition, the information on the usage of the IC card is personal information, and so, it may not be provided from the transportation companies.

The present disclosure has been made in consideration of the problems as referred to above, and has for its object to track the movement of a user with a high degree of accuracy.

The present disclosure in its one aspect provides an information processing apparatus which estimates an action of a user who moves on a route composed of a plurality of segments by using a plurality of transportation means including at least a public transportation facility whose operation schedule is managed, the apparatus comprising a first obtaining unit configured to obtain operation-related data which is data of operation services of the public transportation facility, and which represents a scheduled time of departure and a scheduled time of arrival for each segment; a second obtaining unit configured to obtain a scheduled movement route which is a set of a plurality of segments included in the route on which the user moves; a creation unit configured to obtain location information from a user terminal possessed by the user in a periodic manner, and to create movement track record data including the location information; and an estimation unit configured to estimate, based on the movement track record data and the operation-related data, a transportation means used by the user, and an entering time and a leaving time thereof, with respect to a corresponding segment that is included in the scheduled movement route.

The present disclosure in its another aspect provides an information processing method which is carried out by an information processing apparatus which estimates an action of a user who moves on a route composed of a plurality of segments by using a plurality of transportation means including at least a public transportation facility whose operation schedule is managed, the method comprising a first obtaining step of obtaining operation-related data which is data of operation services of the public transportation facility, and which represents a scheduled time of departure and a scheduled time of arrival for each segment; a second obtaining step of obtaining a scheduled movement route which is a set of a plurality of segments included in the route on which the user moves; a creation step of obtaining location information from a user terminal possessed by the user in a periodic manner, and creating movement track record data including the location information; and an estimation step of estimating, based on the movement track record data and the operation-related data, a transportation means used by the user, and an entering time and a leaving time thereof, with respect to a corresponding segment that is included in the scheduled movement route.

Here, note that the present disclosure can be specified as an information processing apparatus including at least a part of the above-mentioned units. In addition, the disclosure can also be specified as a method that is performed by the information processing apparatus. The above-mentioned processings or units can be implemented in various combinations thereof, as long as technical inconsistency does not occur.

According to the present disclosure, the movement of a user can be tracked with a high degree of accuracy.

### BRIEF DESCRIPTION OF THE DRAWINGS

FIG. 1 is a view explaining a route on which a user moves.

FIG. 2 is a view explaining connections (transfers) carried out by the user and a movement schedule.

FIG. 3 is a schematic diagram of the configuration of a navigation system according to a first embodiment.

FIG. 4A illustrates an example of movement track record data in the first embodiment.

FIG. 4B illustrates an example of movement track record data in the first embodiment.

FIG. 5A illustrates an example of operation-related data in the first embodiment.

FIG. 5B illustrates an example of operation-related data in the first embodiment.

FIG. 6 is a view explaining the outline of processing of estimating the action of the user.

FIG. 7 is a view explaining the outline of processing in the case where location information is missing.

FIG. 8 is a view illustrating data flow between the component elements of the navigation system.

FIG. 9 is a flowchart of action estimation processing carried out by a server device.

FIG. 10 is a view explaining action estimation for segments in which the location information is missing.

### DESCRIPTION OF THE EMBODIMENTS

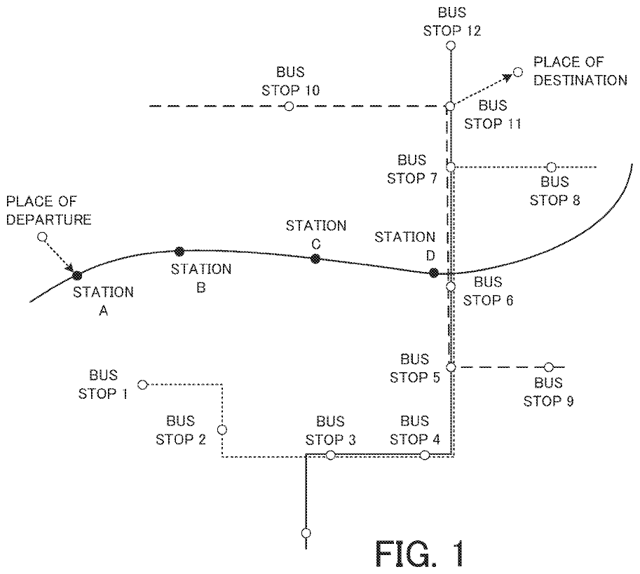

A system for tracking a user who is moving or traveling along a predetermined path or route can be considered. For example, let us consider that a user moves from a place of departure to a place of destination by a transportation network as illustrated in FIG. 1.

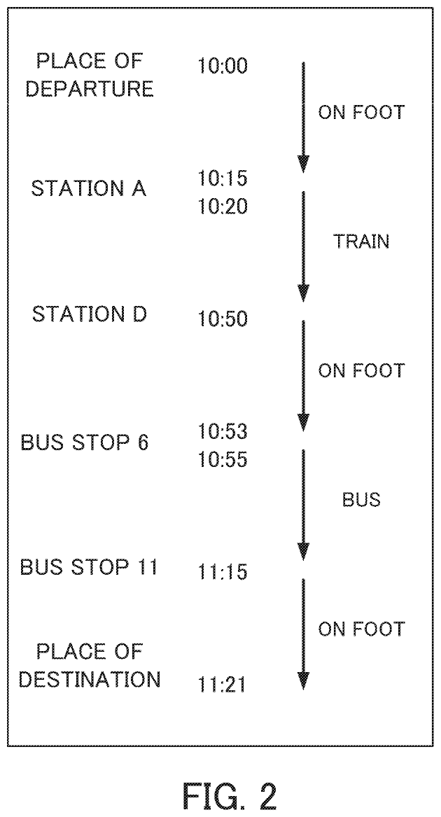

In this case, a route and a movement (travel) schedule as illustrated in FIG. 2 are created by a route search service, for example.

On the other hand, there is a desire or demand for knowing whether the user is moving on the proposed route. In particular, the user may be unable to carryout a prearranged movement, depending upon the time required for transfer, the walking speed of the user, the characteristics of stop-over or via places, etc., used in a route search. However, with conventional technologies, it has been difficult to know to what extent the proposed movement schedule and the actual movement match with each other, as long as there is no feedback from the user.

An information processing apparatus for solving this problem according to the present disclosure is an apparatus that serves to estimate an action of a user who moves on a route composed of a plurality of segments by using a plurality of transportation means including at least a public transportation facility whose operation schedule is managed.

Specifically, the information processing apparatus includes: a first obtaining unit configured to obtain operation-related data which is data of operation services of the public transportation facility, and which represents a scheduled time of departure and a scheduled time of arrival for each segment; a second obtaining unit configured to obtain a scheduled movement route which is a set of a plurality of segments included in the route on which the user moves; a creation unit configured to obtain location information from a user terminal possessed by the user in a periodic manner, and to create movement track record data including the location information; and an estimation unit configured to estimate, based on the movement track record data and the operation-related data, a transportation means used by the user, and an entering time and a leaving time thereof, with respect to a corresponding segment which is included in the scheduled movement route.

The public transportation facility whose operation schedule is managed is a transportation system such as a railroad, a bus or the like, a service diagram (or an operation schedule) of which is determined in advance. The transportation network targeted by the present disclosure is a transportation network in which the user can move by using transportation means including a public transportation facility and other transportation means (e.g., walking, a bicycle, a motorcycle, a private vehicle, etc.).

A segment is a unit zone which constitutes the route. One segment may be a zone connecting between two optional stations, or may be a zone connecting between two optional bus stops. In addition, in cases where a user's movement is carried out except by public transportation facilities, one segment may be a zone connecting between two optional spots or points.

The scheduled movement route is a set of segments over which the user plans to move.

The operation-related data is data including a scheduled time of departure and a scheduled time of arrival for each segment. The operation-related data may be timetable data decided in advance, or may be the timetable data considering actual operation situations (delay time, etc.). The creation unit obtains location information from the user terminal in a periodic manner, and creates movement track record data. The movement track record data is data indicating that the user terminal existed at which location at which time point.

The estimation unit estimates the time points at which the user entered and left each segment and a means of transportation used for the user to move through the segment by making a comparison between the movement track record data and the operation-related data. The transportation means as referred to herein may be categorized as railroad/bus/walking, or may be specified services (train numbers, bus lines, flight numbers, etc.) used by the user.

According to such a configuration, entering and leaving time points and a transportation means can be estimated for each of the segments which constitute the route, thus making it possible to track whether the action of the user was carried out as originally planned.

In addition, during the movement of the user, the user terminal may be either in a first state capable of obtaining location information or in a second state incapable of obtaining location information, and the creation unit may be characterized by creating the movement track record data using only the location information obtained in the case where the user terminal is in the first state.

The user terminal can not always obtain the location information. For example, in the underground, it is difficult to obtain GPS information. In addition, even when the user terminal is on the ground, location information may not be obtained, in cases where the terminal is in a sleep state, or in cases where an application is operating in the background, or the like. In such cases, the movement track record data may be created by using only the location information that was able to be obtained.

Moreover, the movement track record data may be characterized to be data in which the location information and a time point at which the location information was obtained are associated with the segment. With this, for example, in cases where the segment is defined by a station or a bus stop, it becomes possible to estimate the train or service number of a train or bus taken by the user.

Further, the estimation unit may be characterized by deciding a service of the public transportation facility estimated to have been taken by the user for each segment by comparing the movement track record data and the operation-related data with each other. The estimation of the service can be performed by comparing the movement track record data and the operation-related data with each other, and by narrowing down services which are available for relay (connection) or transit.

Furthermore, provision may further be made for an obtaining unit configured to obtain passage information of an IC card used when the user takes the public transportation facility, and the estimation unit may be characterized by deciding the service of the public transportation facility estimated to have been taken by the user for each segment by comparing the operation-related data with at least one of the passage information and the movement track record data.

The passage information is, for example, information to the effect that the user passed through a ticket gate, or information to the effect that the getting on and off of the user occurred. The location information can be complemented by using the passage information.

In addition, the estimation unit may be characterized in that, in cases where the obtaining of the location information was stopped or interrupted in a part of the route, it decides the service of the public transportation facility estimated to have been taken by the user in each intermediate segment for which the location information was not able to be obtained, based on first movement track record data in a segment for which the location information was last obtained, second movement track record data in a segment for which the obtaining of the location information was resumed, and the operation-related data.

For example, in cases where the location information was missing in the middle of the route, a boarding service (train or bus number, etc.) of a public transportation facility in an intermediate segment can be decided in such a manner that the movement track record data and time points before and after that missing location information can be matched with each other (i.e., the user can make a transfer or connection in a reasonable time).

Moreover, provision may be further made for a unit configured to determine whether the movement of the user was carried out in a living sphere of the user, or in a non-living sphere of the user, and it may be characterized in that the walking speed of the user is set to be smaller in the case where the movement of the user is carried out in the non-living sphere, as compared with the case where it is carried out in the living sphere. According to such a configuration, the transfer or connection can be estimated with a higher degree of accuracy.

### First Embodiment

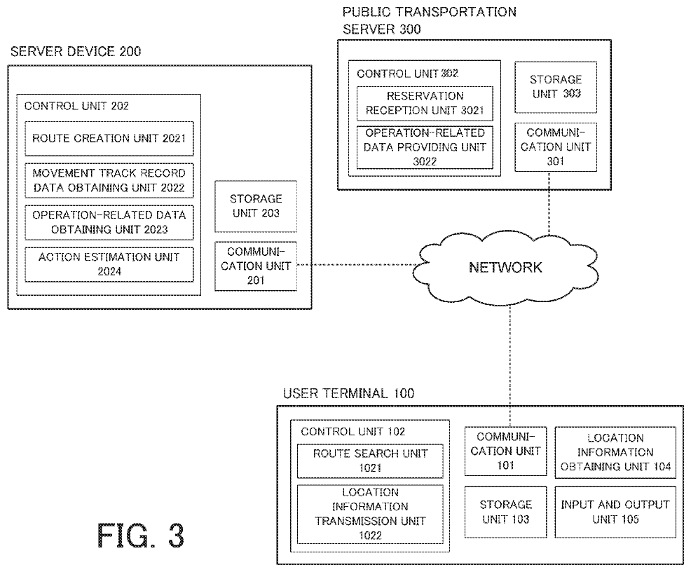

An outline of a navigation system according to a first embodiment of the present disclosure will be described, while referring to FIG. 3. The navigation system according to this embodiment is composed of including a terminal (i.e., a user terminal 100) possessed or held by a user, a server device 200 for providing a navigation service to the user terminal 100, and a public transportation server 300 for managing the operation of public transportation systems or facilities. Note that, in cases where there are a plurality of target users, the number of user terminals 100 may be more than one. In addition, the public transportation server 300 may also be arranged for each transportation system or facility (or each operation entity).

The user terminal 100 is, for example, a smart phone, a portable or cellular phone, or a small-sized computer such as a tablet computer, a personal information terminal, a notebook computer, a wearable computer (a smart watch, etc.), or the like. The user terminal 100 is composed of including a communication unit 101, a control unit 102, a storage unit 103, a location information obtaining unit 104, and an input and output unit 105.

The communication unit 101 is a communication interface for communicating with the server device 200 via a network.

The control unit 102 is a unit that manages the control of the user terminal 100. The control unit 102 is composed of a CPU (Central Processing Unit), for example.

The control unit 102 has, as functional modules, a route search unit 1021 and a location information transmission unit 1022. The individual functional modules may be achieved by executing programs stored in a storage unit such as a ROM (Read Only Memory) by the CPU.

The route search unit 1021 transmits a request for searching for a route (hereinafter, a route search request) to the server device 200, and provides route guidance to the user based on a response obtained. Specifically, the route search unit 1021 obtains a place of departure and a place of destination from the user, and transmits to the server device 200 a request for searching for a route that connects between the place of departure and the place of destination. In addition, the root search unit 1021 provides the user with the route received from the server device 200 through the input and output unit 105 to be described later. Such a function may be achieved by an application program which operates on an operating system.

The location information transmission unit 1022 transmits to the server device 200 location information (to be described later) on a terminal obtained by the location information obtaining unit 104 during the navigation by the route search unit 1021.

The storage unit 103 is a unit that stores information, and is composed of a storage medium such as a RAM, a magnetic disc, a flash memory, or the like.

The location information obtaining unit 104 is a unit that obtains a current location of the user terminal 100, and is typically composed of including a GPS receiver, etc. The information obtained by the location information obtaining unit 104 is transmitted to the control unit 102.

The input and output unit 105 is an interface for presenting information to the user and for receiving an input of information from the user. The input and output unit 105 is composed of including a display unit or a touch panel, for example.

Next, the configuration of the server device 200 will be described.

The server device 200 is a device that creates, based on a route search request received from each of a plurality of user terminals 100, a route connecting between a designated place of departure and a designated place of destination and information on transfers or connections of public transportation facilities for moving on the route. Thereafter, the information on the route and transfers or connections is referred to as navigation information.

In addition, the server device 200 has a function of obtaining the location information of each user terminal 100 to which the navigation information was transmitted in a periodic manner, and estimating the action of the user who possesses or holds the user terminal 100. With this, it becomes possible to determine whether the action taken by the user matches the navigation information.

The server device 200 is composed of including a communication unit 201, a control unit 202, and a storage unit 203.

The communication unit 201 is a communication interface, similar to the communication units 101, for communicating with the user terminal 100 and the public transportation server 300 via the network.

The control unit 202 is a unit that manages the control of the server device 200. The control unit 202 is composed of a CPU, for example.

The control unit 202 includes, as functional modules, a route creation unit 2021, a movement track record data obtaining unit 2022, an operation-related data obtaining unit 2023, and an action estimation unit 2024. Each of these individual functional modules may be achieved by executing programs stored in a storage unit such as a ROM by the CPU.

The route creation unit 2021 searches for and creates the route connecting between the designated places of departure and destination according to the route search request obtained from the user terminal 100. The creation of the route can be carried out by a well-known technique with reference to map data stored in the storage unit 203 to be described later, for example. In addition, the creation of the route may be carried out with reference to diagram information on the public transportation facilities. The diagram information of the public transportation facilities may be stored in the storage unit 203, or may be obtained from the public transportation server 300. Moreover, the route creation unit 2021 transmits a seat reservation request, etc., to the public transportation server 300, as needed.

The movement track record data obtaining unit 2022 obtains the location information from the user terminal 100 to which the navigation information was transmitted in a periodic manner, and creates data showing how the user terminal 100 receiving the navigation information is moving (hereinafter, movement track record data).

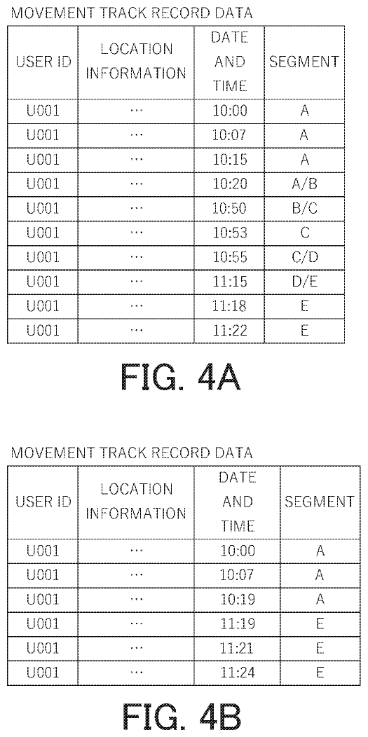

In this embodiment, the movement track record data is a table including user's identifiers (ID), location information (e.g., latitude and longitude), date and time information, and segments (indicating on which segment the user is moving), as illustrated in FIGS. 4A and 4B. The movement track record data obtaining unit 2022 creates a new record each time it receives location information from the user terminal 100, and stores it in the storage unit 203.

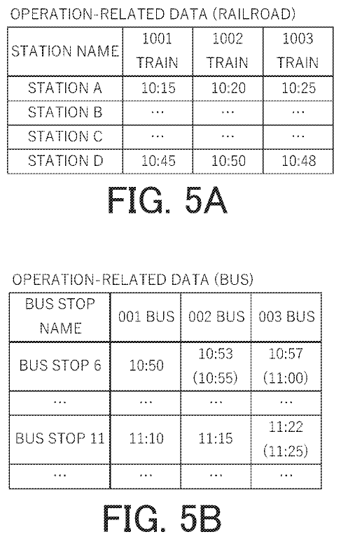

The operation-related data obtaining unit 2023 obtains data on the operation of the public transportation facilities (hereinafter, operation-related data) from the public transportation server 300. In this embodiment, the operation-related data is data (timetable data) showing the operation schedule of trains or buses. As illustrated in FIGS. 5A and 5B, operation bases such as train stations or bus stops, as well as departure times, passage times and arrival times at each operation base, are recorded in the operation-related data for each operation train number or service number.

The action estimation unit 2024 estimates an action actually taken by the user for each segment based on the movement track record data obtained by the movement track record data obtaining unit 2022, and the operation-related data obtained by the operation-related data obtaining unit 2023. The details thereof will be described later.

The storage unit 203 is a unit that stores information, and is composed of a storage medium such as a RAM, a magnetic disc, a flash memory, or the like.

Next, the configuration of the public transportation server 300 will be described.

The public transportation server 300 is a server device that manages the operation of the public transportation systems or facilities. Specifically, the public transportation server 300 is a device that provides the operation-related data (timetable data) of the public transportation facilities, and receives a reservation for a transportation facility in which seats are designated. The public transportation server 300 may exist for each transportation system or facility, or may exist for each transportation company. For example, the public transportation server 300 may manage transportation systems or facilities including a plurality of train and/or bus lines which are operated by the same company.

The public transportation server 300 is composed of including a communication unit 301, a control unit 302, and a storage unit 303.

The communication unit 301 is a communication interface, similar to the communication unit 201, for communicating with the server device 200 via the network.

The control unit 302 is a unit that manages the control of the public transportation server 300. The control unit 302 is composed of a CPU, for example.

The control unit 302 has, as functional modules, a reservation reception unit 3021 and an operation-related data providing unit 3022. Each of these individual functional modules may be achieved by executing programs stored in a storage unit such as a ROM by the CPU.

The reservation reception unit 3021 books or reserves, based on a request from the server device 200, a seat or operation (service) of a corresponding transportation facility. An object for booking or reservation may be a reserved seat of a higher-category (superior) train, a reserved seat of a highway (intercity express) bus, a reserved seat of a ship or airline, a taxi (car allocation), etc., for example. The reservation reception unit 3021 may have a function of settling a payment, upon the establishment of a reservation. Here, note that the reservation reception unit 3021 may perform settlement of accounts with respect to charged seats other than reserved seats.

The operation-related data providing unit 3022 provides the server device 200 with the operation-related data of the corresponding transportation system or facility. As illustrated in FIGS. 5A and 5B, the operation-related data is data in which stations or bus stops, departure times, passage times, and arrival times at each operation base (station or bus stop) are recorded for each operation train number or service number. Here, note that the operation-related data may show scheduled operation times, or may reflect current operation situations (delays, etc.). Times in parentheses in FIG. 5B represent the time points (actual scheduled times of arrival) on which operation delays are reflected. In an example illustrated in FIG. 5B, a scheduled original passage time at a bus stop 6 for a bus of service (line) No. 002 (hereafter, a 002 bus) is 10:53, but in actuality, it is shown that passage of this bus at this bus stop will be expected at 10:55. Thus, the operation-related data may be updated according to the situation, as needed.

In this embodiment, the public transportation server 300 has stored the operation-related data in all time zones, and provides apart thereof (i.e., data corresponding to a designated time zone) in response to a request of the server device 200.

Subsequently, reference will be made to an outline of processing in which the server device 200 creates the movement track record data by using the location information obtained from the user terminal 100 in a periodic manner, and estimates the user's action in each segment.

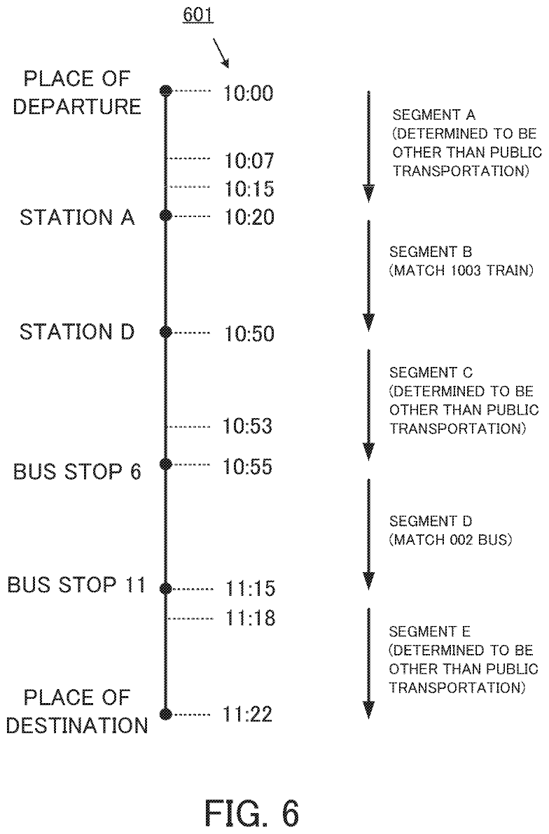

Here, it is assumed that the server device 200 (i.e., the movement track record data obtaining unit 2022) obtains the location information from the user terminal 100 possessed by the user who moves in the transportation network illustrated in FIG. 1 on the schedule indicated in FIG. 2 at timings denoted by a reference numeral 601 in FIG. 6.

In an example of FIG. 6, it can be determined that four pieces of location information received from 10:00 until 10:20 correspond to a segment A. In addition, it can be determined that two pieces of location information received from 10:20 until 10:50 correspond to a segment B. Similarly, it can be determined that three pieces of location information received from 10:50 until 10:55 correspond to a segment C, two pieces of location information received from 10:55 until 11:15 correspond to a segment D, and three pieces of location information received from 11:15 until 11:22 correspond to a segment E, respectively.

When these pieces of location information are mapped to the segments, the movement track record data as illustrated in FIG. 4A will be obtained.

Then, the server device 200 (the action estimation unit 2024) compares the movement track record data obtained in this manner with the operation-related data of the public transportation facilities, and determines what means of transportation is used by the user who moved in each segment.

For example, because there exists no public transportation facility which connects between the place of departure and a station A, the action estimation unit 2024 determines that the user moved through the segment A by using something other than the public transportation facilities. A movement start time point in the segment A (i.e., a time point at which the user entered the segment A) becomes 10:00, and a movement end time point in the segment A (a time point at which the user left the segment A) becomes 10:20.

Because there is a railroad service as a public transportation facility connecting between a station A and a station D, the action estimation unit 2024 obtains the operation-related data for the railroad service from the public transportation server 300 (the operation-related data providing unit 3022), and makes appropriate comparison or collation thereof. From the example of FIG. 5A, it can be understood that as candidates for trains that can enter the segment B at 10:20 and leave the segment B at 10:50, there are two trains including a train with train No. 1002 (hereafter, a 1002 train) and a train with train No. 1003 (hereafter, a 1003 train), however, in consideration of transfer time, the 1003 train is extracted or selected. That is, it is determined that the user moved through the segment B by the use of the 1003 train. Here, note that the transfer time may be calculated in consideration of the walking speed of the user. The walking speed of the user can be set to a predetermined value according to age or sex, for example.

Because there exists no public transportation facility connecting between the station D and the bus stop 6, the action estimation unit 2024 determines that the user moved through the segment C by using something other than the public transportation facilities. A movement start time point in the segment C becomes 10:50, and a movement end time point in the segment C becomes 10:55.

Because there is a bus service as a public transportation facility connecting between the bus stop 6 and a bus stop 11, the action estimation unit 2024 obtains the operation-related data for the bus service from the public transportation server 300 (the operation-related data providing unit 3022), and makes appropriate comparison or collation thereof. From the example of FIG. 5B, the 002 bus that can enter the segment D at 10:55 and can leave the segment D at 11:15 is extracted as a candidate (because an original departure schedule of the bus is at 10:53, but the departure time is changed to 10:55 due to a delay).

Because there exists no public transportation facility connecting between the bus stop 11 and the place of destination, the action estimation unit 2024 determines that the user moved through the segment E by using something other than the public transportation facilities. A movement start time point in the segment E becomes 11:15, and a movement end time point in the segment E becomes 11:22.

In this manner, the server device 200 maps the location information obtained from the user terminal 100 into the segments in a periodic manner, and decides, by referring to the operation-related data, the means of transportation at the time when the user moved through each segment, as well as the entering and leaving time points in each segment.

However, it is not necessarily the case that in all the segments, a sufficient number of pieces of location information can be obtained from the user terminal 100, as illustrated in FIG. 6. For example, in cases where a train is running underground, or in cases where a bus is passing through a tunnel, there may occur timing at which the location information can not be obtained. Such a case may also occur when a navigation application is not operating on the user terminal 100 (i.e., in cases where it is in a sleep state).

In this embodiment, in order to cope with such a case, the estimation of the user's action is performed for each segment by using only the location information that was able to be received.

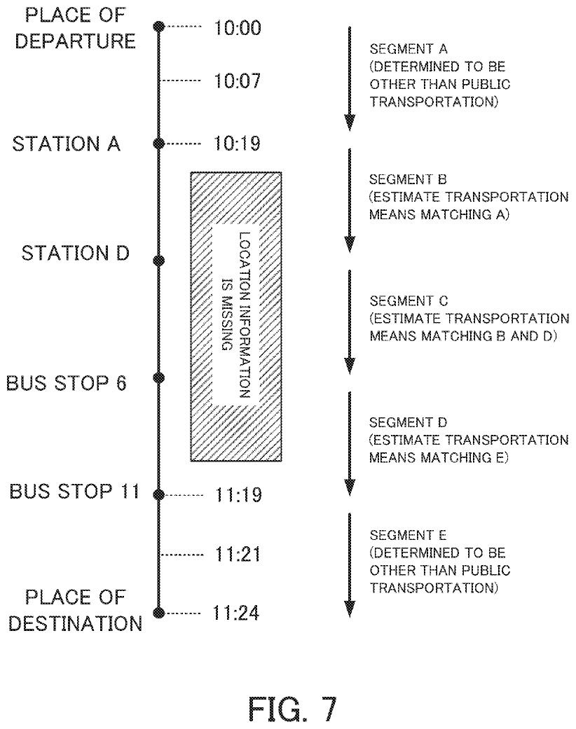

FIG. 7 is a view explaining the case where location information was missing, i.e., the transmission of location information was temporarily interrupted in the middle of user's movement. In this example, it is assumed that periodic transmission of location information was interrupted during user's movement by using a train and a bus.

In an example of FIG. 7, it can be determined that three pieces of location information received from 10:00 until 10:19 correspond to the segment A. Also, it can be determined that three pieces of location information received from 11:19 until 11:24 correspond to the segment E. When these pieces of location information are mapped to the segments, the movement track record data as illustrated in FIG. 4B will be obtained.

In this example, information does not exist for the segments B, C, and D. Accordingly, the action estimation unit 2024 estimates the action of the user in the intermediate segments based on the movement track record data in the segments before and after the intermediate segments.

For example, for the segment B, a time point at which the user took a train can be estimated based on a leaving time in the segment A. In the case of this example, as a result of adding the time required for transfer to an arrival time point at which the user arrived at the station A, it can be determined that the possibility of the user having taken the 1003 train is the highest. That is, an estimated entering time point in the segment B becomes 10:25, and an estimated leaving time point in the segment B becomes 10:48.

For the segment D, a time point at which the user got off the bus can be estimated based on an entering time point in the segment E. In the case of this example, from a time point at which the user (bus) arrived at the bus stop 11, it can be determined that the possibility of the user having got on the 002 bus is the highest. That is, an estimated entering time point in the segment D becomes 10:55, and an estimated leaving time point in the segment D becomes 11:15.

For the segment C, a means of transportation as well as an entering time point and a leaving time point is estimated so that they are consistent with the estimated results in the segments B and D. For example, it is assumed that the user moved on foot, entered the segment C at 10:48, and left there at 10:55.

In this manner, in cases where there has occurred a period of time (an intermediate segment (s)) in which location information can not be obtained from the user terminal 100, the server device 200 compares the movement track record data in the segments before and after the intermediate segment(s) with the operation-related data, and estimates the user's action in the intermediate segment (s).

Hereafter, a specific processing method for achieving the above-mentioned function will be described.

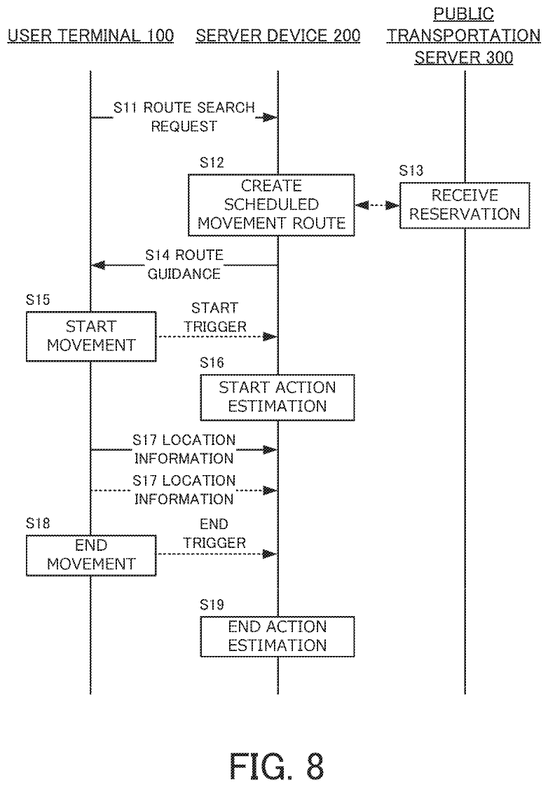

FIG. 8 is a view illustrating the processing carried out by each component which constitutes the navigation system according to this embodiment, and the flow of data between the components.

First, in step S11, the user issues a route search request through the user terminal 100 (the route search unit 1021, e.g., a navigation application). The route search request includes information which designates a place of departure and a place of destination. The route search request is transmitted to the server device 200.

The server device 200 (the route creation unit 2021) having received the route search request creates a route (a scheduled movement route) connecting between the place of departure and the place of destination (step S12). Here, note that the route creation unit 2021 may transmit an appointment or reservation request to the public transportation server 300, as needed. In this case, the public transportation server 300 (the reservation reception unit 3021) may secure or obtain a seat, etc., according to the reservation request, and may return a result (step S13).

Here, note that the scheduled movement route may include a scheduled movement start time point and a scheduled movement end time point in each segment.

The scheduled movement route created by the route creation unit 2021 is transmitted to the user terminal 100 (the route search unit 1021) (step S14), and route guidance is started.

When the user has started a movement, information to the effect that the user has started a movement (a start trigger) is transmitted to the server device 200 (step S15).

The fact that the user has started a movement may be determined based on an operation performed on the navigation application by the user, or it may be automatically detected by the user terminal 100.

In step S16, the server device 200 (the action estimation unit 2024) starts the estimation of the action of the user. In the meantime, location information is transmitted to the server device 200 from the user terminal 100 in a periodic manner (step S17).

When the user has ended the movement, information to the effect that the movement of the user has ended (an end trigger) is transmitted to the server device 200 (step S18).

The fact that the user has ended the movement may be determined based on an operation performed on the navigation application by the user, or it may be automatically detected by the user terminal 100. With this, the action estimation by the server device 200 ends (step S19).

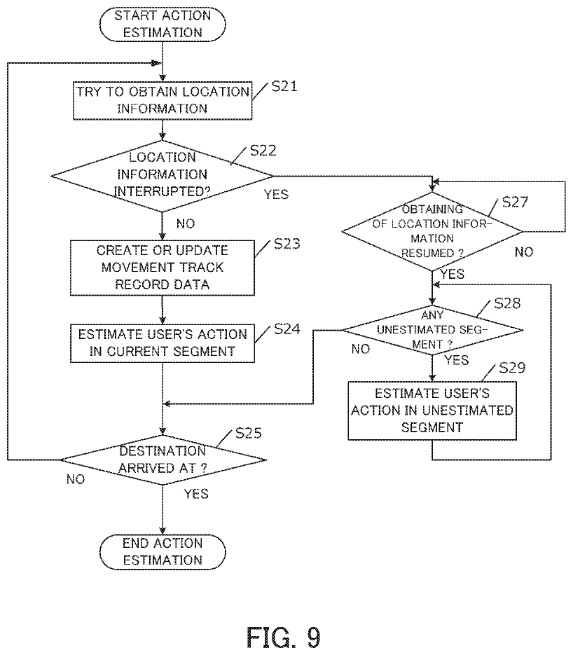

FIG. 9 is a flowchart of action estimation processing carried out by the server device 200. A flow or routine illustrated in the flowchart of FIG. 9 is repeatedly carried out in a period of time from step S16 to step S19.

First, in step S21, the movement track record data obtaining unit 2022 requests the transmission of location information to the user terminal 100. In response to the request, the user terminal 100 (the location information transmission unit 1022) obtains location information through the location information obtaining unit 104, and transmits it to the server device 200. The location information thus obtained is temporarily stored in the server device 200. Here, note that in this example, the server device 200 requested the transmission of location information, but instead, the user terminal 100 may transmit location information in an active manner. Also, note that the processing is continued even in cases where the server device 200 fails to obtain location information (including the case where there is no response from the user terminal 100, or the case where location information is not transmitted from the user terminal 100 in a prescribed period or interval).

Subsequently, in step S22, the movement track record data obtaining unit 2022 determines whether the obtaining of location information was interrupted for a fixed period of time or more. The fixed period of time can be a time (3 minutes, 5 minutes, 10 minutes, or the like) set in advance, for example, but is not limited to this.

Here, in cases where a negative determination is made, then in step S23, the movement track record data obtaining unit 2022 creates or updates the movement track record data based on the received location information. Specifically, as illustrated in FIGS. 4A and 4B, user IDs, location information, dates and times, and segments are stored while being associated with one another. An association between location information and each segment can be made by referring to the scheduled movement route created in step S12.

Thereafter, in step S24, the action estimation unit 2024 estimates the action of the user in a corresponding segment. In this step, first, the operation-related data obtaining unit 2023 obtains the operation-related data of a public transportation facility available in a target segment and a target time zone. Then, by making a comparison between target movement track record data and the operation-related data thus obtained, it is determined whether there is a train or service (line) number that can be taken by the user. In this step, for each segment, a means of transportation (including whether or not a public transportation facility was used, and the name of the train or service (line) number in the case where the public transportation facility was used) and entering and leaving time points in the segment concerned are estimated.

Note that in cases where a means of transportation can not be uniquely specified, a plurality of candidates may be retained. In addition, a likelihood may also be given to each of the plurality of candidates, or the plurality of candidates may also be ranked according to the likelihoods.

Then, in step S25, the action estimation unit 2024 determines whether the user has arrived at the place of destination. Here, in cases where a negative determination is made, a return is made to step S21, and the processing is continued.

Hereafter, the case where an affirmative determination is made in step S22 will be described.

In cases where the obtaining of location information is interrupted and a predetermined period of time has elapsed, the processing shifts to step S27. In step S27, the processing stands by until the obtaining of location information is resumed. In cases where the obtaining of location information is resumed, the processing goes to step S28.

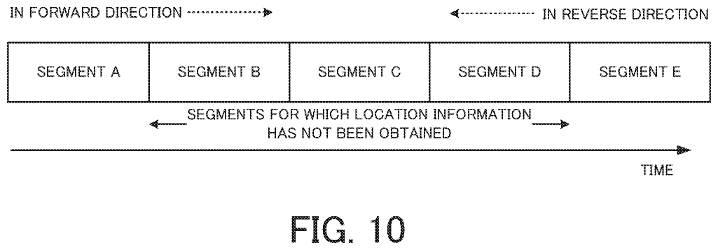

In steps S28 through S29, for each of the segments for which location information was not able to be obtained, the estimation of the user's action is performed by a method different from that in step S24. Here, an explanation thereof will be made according to an example of FIG. 10. In this example, it is assumed that location information was not able to be obtained for the segments B, C, and D.

First, in step S28, it is determined whether there remains any segment (unestimated segment) for which the user's action was not able to be estimated. In cases where there is an unestimated segment, then in step S29, the user's action in the unestimated segment is estimated by using the operation-related data obtained by the operation-related data obtaining unit 2023 and the movement track record data obtained by the movement track record data obtaining unit 2022.

Specifically, a boundary between a segment (estimated segment) for which the estimation of the user's action (hereinafter, also referred to as the action estimation) has been completed and the unestimated segment (e.g., a boundary between the segment A and the segment B) is specified, and a train or service (line) number of a public transportation facility to which a transfer or connection can be performed in a reasonable time is extracted. In cases where there is no available public transportation facility, it is decided that the user moved by using something other than the public transportation facilities. As a result of this, the means of transportation used by the user in the unestimated segment (e.g., the train or service number of the public transportation facility taken by the user) and the entering and leaving time points in the unestimated segment can be estimated.

When the action estimation has been completed for a certain unestimated segment, this unestimated segment is changed to an estimated segment, and the above-mentioned processing is repeated until there exists no unestimated segment.

Here, note that the action estimation processing may be carried out in order of time point, but may be carried out from both of a segment for which location information was able to be obtained at the last time, and a segment for which the obtaining of location information was resumed. That is, it may be carried out in parallel in a forward direction and in a reverse direction with respect to a time base direction.

For example, the action estimation of the intermediate segments may be carried out by the following procedures: (1) the segment B is estimated based on the movement track record data corresponding to the segment A; (2) the segment D is estimated based on the movement track record data corresponding to the segment E; and (3) the segment C is estimated based on the estimated results of the segments B and D.

In this case, in cases where the result of having estimated in the forward direction and the result of the estimation performed in the backward direction are not consistent with each other in terms of time points (e.g., in cases where a transfer or connection becomes impossible in an intermediate segment), a retry may be performed by shifting either one of the train or service numbers in a direction to eliminate the inconsistency.

When no unestimated segment exists, the processing shifts to step S25.

In step S25, it is determined whether the user has arrived at the place of destination. In cases where the user has not arrived at the place of destination, the processing returns to step S21. On the other hand, in cases where the user has arrived at the place of destination, the processing is ended. The information obtained as a result of the processing (the information on the user's action) is stored in the storage unit 203, or is provided to an external device.

As explained above, in the navigation system according to the first embodiment, the action of the user having passed and moved through a plurality of segments can be tracked. In particular, even in cases where the transmission of location information is temporarily interrupted in an intermediate segment(s), the action of the user in the intermediate segment(s) can be estimated by comparing the location information obtained before and after each intermediate segment with the operation-related data of the public transportation facility.

### Modification of the First Embodiment

In the first embodiment, the moving speed of the user at the time of not using the public transportation facilities has been set to a predetermined value. However, in practice, the moving speed of a person (e.g., the walking speed and the time required for transfer, etc.) may change depending on environment. Accordingly, by determining whether the movement of a target user was performed in a living sphere, or in a non-living sphere, the walking speed of the user may be corrected based on a result of determination.

A determination of the living sphere can be made based on, for example, the amount of the movement track record data in the past stored or accumulated in the storage unit 203. For example, it is estimated that a segment with a large number of movements in a past predetermined period of time is a familiar path. Accordingly, for such a segment, the walking speed can be set faster, or the time required at the time of a transfer can be set shorter, in comparison with a segment for which the number of movements in the past predetermined period of time is small. Such a determination may be made per route, or may be made per segment.

In addition, in the first embodiment, it is assumed that the public transportation server 300 can provide operation-related data in all time zones, but some companies may not provide operation-related data at past time points. In such a case, when the action of the user in the past is going to be estimated, there may occur an inconvenience that the operation-related data can not be obtained.

In order to cope with this, when starting the action estimation processing, the operation-related data obtaining unit 2023 may obtain in advance the operation-related data for the transportation facilities that can be used by the user. For example, supposing that an initial action schedule is disturbed, the operation-related data in a predetermined period of time may be obtained and cached for all the available public transportation facilities. In addition, the caching of the operation-related data may be performed at the timing at which the obtaining of location information is interrupted.

Moreover, in the first embodiment, the server device 200 makes the action estimation in real time during the movement of the user, but after the user ends the movement, the action estimation may be made ex post based on the stored or accumulated movement track record data.

Further, in the first embodiment, the action estimation is made for all the segments, but in cases where there exists a segment for which the action of the user can not be narrowed down, the action estimation may be performed by excluding this segment.

In addition in the first embodiment, there has been mentioned the example in which the scheduled movement route has been decided in advance, but it is not necessarily needed that the movement route of the user has been decided in advance. That is, the action estimation processing illustrated in FIG. 9 may be started in a state where there exists no scheduled movement route, and the segments through which the user moved may be estimated ex post.

### Second Embodiment

In a second embodiment according to the present disclosure, the estimation of user' action is made by using together passage information of an IC card used by a user when the user took public transportation facilities.

This second embodiment is different from the first embodiment in that the public transportation server 300 provides the server device 200 with the passage information of the IC card, and that the server device 200 makes the estimation of user's action in consideration of the passage information.

Specifically, the control unit 202 requests the public transportation server 300 to provide it with passage information of a specific user, and in response to this, the control unit 302 transmits the passage information of the specific user in a predetermined period of time to the server device 200. In addition, the action estimation unit 2024 estimates the action of the user by further using the received passage information.

The passage information of the IC card is accurate as compared with the location information on the user terminal 100. Accordingly, in the second embodiment, in cases where passage information corresponding to the entering and leaving of the user with respect to a segment is obtained, the entering time or leaving time for the segment is decided by using the passage information. The processing of obtaining the passage information of the target user is carried out independently of the processing of FIG. 9, and the results of the estimation performed in steps S24 through S29 are overwritten by the passage information thus obtained, as needed.

According to such a configuration, it becomes possible to further improve accuracy in the estimation of user's action.

Here, note that in the second embodiment, the public transportation facilities available to the user with an IC card has been exemplified, the passage information may be obtained from other than the public transportation facilities. For example, lending information and return information generated in car sharing, in bicycle sharing, etc., may be handled as passage information. In this case, the server device 200 may perform communication with a device that is managed by a sharing company, and may obtain the lending information and the return information that are associated with location information.

(Modifications)

The above-mentioned embodiments are only some examples, and the present disclosure can be implemented while being changed or modified suitably without departing from the spirit and scope of the disclosure.

For example, the processings, units and devices explained in this disclosure can be implemented in various combinations thereof, as long as technical inconsistency does not occur.

Moreover, the processing(s) explained as carried out by a single device may be carried out by a plurality of devices. Alternatively, the processing(s) explained as carried out by different devices may be carried out by a single device. In a computer system, whether each function of the disclosure is achieved by what kind of hardware configuration (server configuration) can be changed in a flexible manner.

The present disclosure can also be achieved by supplying a computer program to a computer which implements the functions explained in the above-mentioned embodiments, and by reading out and executing the program by one or more processors of the computer. Such a computer program may be supplied to the computer by a non-transitory computer readable storage medium which can be connected with a system bus of the computer, or may be supplied to the computer through a network.

The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, any type of medium suitable for storing electronic commands.

What is claimed is:

1. An information processing apparatus which estimates an action of a user who moves on a route composed of a plurality of segments by using a plurality of transportation means including at least a public transportation facility whose operation schedule is managed, the apparatus comprising:
a first obtaining unit configured to obtain operation-related data which is data of operation services of the public transportation facility, and which represents a scheduled time of departure and a scheduled time of arrival for each segment;
a second obtaining unit configured to obtain a scheduled movement route which is a set of a plurality of segments included in the route on which the user moves;
a creation unit configured to obtain location information from a user terminal possessed by the user in a periodic manner, and to create movement track record data including the location information; and
an estimation unit configured to estimate, based on the movement track record data and the operation-related data, a transportation means used by the user, and an entering time and a leaving time thereof, with respect to a corresponding segment that is included in the scheduled movement route.

2. The information processing apparatus according to claim 1, wherein
during the movement of the user, the user terminal is either in a first state capable of obtaining location information or in a second state incapable of obtaining location information; and
the creation unit creates the movement track record data by using only the location information obtained in the case where the user terminal is in the first state.

3. The information processing apparatus according to claim 1, wherein
the movement track record data is data in which the location information and a time point at which the location information was obtained are associated with the segment.

4. The information processing apparatus according to claim 3, wherein
the estimation unit decides a service of the public transportation facility estimated to be taken by the user for each segment by comparing the movement track record data and the operation-related data with each other.

5. The information processing apparatus according to claim 3, further comprising:
an obtaining unit configured to obtain passage information of an IC card used when the user takes the public transportation facility;
wherein the estimation unit decides a service of the public transportation facility estimated to have been taken by the user for each segment by comparing the operation-related data with at least one of the passage information and the movement track record data.

6. The information processing apparatus according to claim 3, wherein
in cases where the obtaining of the location information was stopped in apart of the route, the estimation unit decides a service of the public transportation facility estimated to have been taken by the user in each intermediate segment for which the location information was not able to be obtained, based on first movement track record data in a segment for which the location information was last obtained, second movement track record data in a segment for which the obtaining of the location information was resumed, and the operation-related data.

7. The information processing apparatus according to claim 1, further comprising:
a unit configured to determine whether the movement of the user was carried out in a living sphere of the user, or in a non-living sphere of the user;
wherein a walking speed of the user is set to be smaller in the case where the movement of the user is carried out in the non-living sphere, as compared with the case where it is carried out in the living sphere.

8. An information processing method which is carried out by an information processing apparatus which estimates an action of a user who moves on a route composed of a plurality of segments by using a plurality of transportation means including at least a public transportation facility whose operation schedule is managed, the method comprising:
a first obtaining step of obtaining operation-related data which is data of operation services of the public transportation facility, and which represents a scheduled time of departure and a scheduled time of arrival for each segment;
a second obtaining step of obtaining a scheduled movement route which is a set of a plurality of segments included in the route on which the user moves;
a creation step of obtaining location information from a user terminal possessed by the user in a periodic manner, and creating movement track record data including the location information; and
an estimation step of estimating, based on the movement track record data and the operation-related data, a transportation means used by the user, and an entering time and a leaving time thereof, with respect to a corresponding segment that is included in the scheduled movement route.
